(19) United States
(12) Patent Application Publication
(10) Pub. No.: US 2014/0158767 A1
(43) Pub. Date: Jun. 12, 2014

(54) DATA READER

(71) Applicant: Jonathan E. Ramaci, Isle of Palms, SC (US)

(72) Inventor: Jonathan E. Ramaci, Isle of Palms, SC (US)

(21) Appl. No.: 13/892,866

(22) Filed: May 13, 2013

Related U.S. Application Data
(60) Provisional application No. 61/647,425, filed on May 15, 2012.

(51) Int. Cl. G06K 7/01; G06K 7/08

(52) U.S. Cl. CPC G06K 7/01; G06K 7/087
USPC 235/449; 235/435

(57) ABSTRACT

Embodiments of the invention are directed to a data reader for reading data from a device associated with a user. In various embodiments, the data reader is or includes a magnetic strip reader, a chip card reader, a Near Field Communication device or other RFID device, an IR communication device or other communication device configured to read, extract or otherwise receive data or information associated with a user, such as financial data, personal data or otherwise. In some embodiments, the data reader reads financial data such as bank account data from a transaction device such as a bank card (credit and/or debit), a chip card or the like and communicates some or all the data to another device, such as a transaction apparatus and/or a mobile device of a user.

### FIELD

In general, embodiments of the invention relate to methods, systems and computer program products for reading data from a device associated with a user.

### BACKGROUND

Today, most individuals carry several financial items with him/her on a daily bases. Most individuals have multiple credit cards, debit cards, gift cards, coupons, loyalty cards, and/or the like that he/she carries. Along with the several financial items, individuals also carry identification items such as driver's license, identification cards, access cards, and the like on a daily bases. As such, most individuals end up carrying multiple items with him/her each time he/she goes anywhere.

These items, typically several of them, become cumbersome when an individual carries all of the items with him/her. Therefore these items are typically stored in a purse, wallet, pocket, or the like when the individual leaves his/her home. However, again, the purse, wallet, pocket, or the like may also become cumbersome based on the number of financial and/or identification items that an individual may accumulate and carry with him/her.

These financial and/or identification items are also important to the individual that is carrying the item. For example, the typical financial item may be associated with a financial account of the individual. An identification card may be associated with an individual's social security number, home, place of work, etc. However, rarely do individuals carrying these items secure them more than simply placing the items in his/her pocket or purse.

Therefore a need exists for a method and apparatus for the consolidation of the various financial and/or identification items in a secure manner.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

In summary, embodiments of the invention are directed to a data reader for reading data from a device associated with a user. In various embodiments, the data reader is or includes a magnetic strip reader, a chip card reader, a Near Field Communication device or other RFID device, an Infrared (IR) communication device or other communication device configured to read, extract or otherwise receive data or information associated with a user, such as financial data, personal data or otherwise. In some embodiments, the data reader reads financial data such as bank account data from a transaction device such as a bank card (credit and/or debit), a chip card or the like and communicates some or all the data to another device, such as a transaction apparatus 130 and/or a mobile device 150 of a user.

According to embodiments of the invention, a data reader for capturing data from a user device includes a device reader for reading data from the user device; and a connector in electrical communication with the device reader, the connector configured for communicating some or all the data read from the user device. In some embodiments, the data reader includes a magnetic strip reader for reading data from a magnetic strip of a card. In some embodiments, the connector comprises a micro-USB connector. In some such embodiments, the micro-USB connector comprises a non-standard connection configuration, and the connector comprises a first pin having a standard assignment of power is not assigned power. In some of these embodiments, the micro-USB connector includes a fourth pin having a standard assignment of unused is assigned power.

In some embodiments, the data reader includes a memory device; and a processing device configured to access computer readable program code stored in the memory device, the computer readable program code structured to cause the processing device to perform the steps of encoding some or all the data read from the device reader; and initiating communication of the encoded data to a transaction device or a mobile device. In some such embodiments, the encoding comprises interleaving data read from multiple data areas. In some such embodiments, the multiple data areas are three tracks of a magnetic strip of a card.

In other embodiments, initiating communication comprises initiating communication of the encoded data as a data bitstream. In some such embodiments, initiating communication comprises initiating communication of a clock signal for use in decoding the encoded data bitstream.

In some embodiments, the data reader also includes a memory device; and a processing device configured to access computer readable program code stored in the memory device, the computer readable program code structured to cause the processing device to perform the steps of determining identifying information from the read data, retrieving stored identification information, comparing the determined identifying information with the retrieved identification information, and if the determined identifying information matches the retrieved identification information, initiating communication of some or all the read data to a transaction device or a mobile device.

In some embodiments, the data reader also includes a memory device; and a processing device configured to access computer readable program code stored in the memory device, the computer readable program code structured to cause the processing device to perform the steps of encrypting some or all the data read from the device reader; and initiating communication of the encrypted data to a transaction device or a mobile device.

According to embodiments of the invention, a computer program product includes a non-transitory computer readable medium having computer executable instructions stored therein, the computer executable instructions configured to cause a processing device of a data reader to perform the steps of reading data from the user device and initiating communicating some or all the data read from the user device. In some such embodiments, the computer executable instructions are configured to cause the processing device of the data reader to perform the steps of initiating reading data from a magnetic strip of a card.

In some embodiments, the computer executable instructions are configured to cause the processing device of the data reader to perform the steps of encoding some or all the data read from the device reader; and initiating communication of the encoded data to a transaction device or a mobile device. In some such embodiments, the encoding comprises interleaving data read from multiple data areas.

In some embodiments, the computer executable instructions are configured to cause the processing device of the data reader to perform the steps of initiating communication of the encoded data as a data bitstream. In some embodiments, the computer executable instructions are configured to cause the processing device of the data reader to perform the steps of initiating communication of a clock signal for use in decoding the encoded data bitstream. In some embodiments, the computer executable instructions are configured to cause the processing device of the data reader to perform the steps of determining identifying information from the read data; retrieving stored identification information; comparing the determined identifying information with the retrieved identification information; and if the determined identifying information matches the retrieved identification information, initiating communication of some or all the read data to a transaction device or a mobile device.

In some embodiments, the computer executable instructions are configured to cause the processing device of the data reader to perform the steps of encrypting some or all the data read from the device reader and initiating communication of the encrypted data to a transaction device or a mobile device.

The following description and the annexed drawings set forth in detail certain illustrative features of one or more embodiments of the invention. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, wherein:

FIG. 1 is a block diagram illustrating an environment 101 in which a data reader 100 operates according to embodiments of the invention;

FIG. 2 is a flowchart illustrating a method 200 for capturing data using the data reader according to embodiments of the invention according to embodiments of the invention;

FIG. 3 is a flowchart illustrating a method 300 including various additional optional steps that may be performed during a data capture using the data reader according to embodiments of the invention;

FIGS. 4A, 4B, 4C, and 4D are illustrations of a system 400 including a data reader 401 according to embodiments of the invention;

FIGS. 5A and 5B are illustrations of a data reader 500 according to embodiments of the invention; and

FIGS. 6A and 6B are illustrations of a data reader without its housing according to embodiments of the invention.

### DETAILED DESCRIPTION OF EMBODIMENTS OF THE INVENTION

This provisional application is filed concurrently with related provisional applications titled “SECURE DATA STORAGE AND TRANSACTION SYSTEM”, titled “DYNAMICALLY RE-PROGRAMMABLE TRANSACTION CARD”, titled “VIRTUAL CURRENCY SYSTEM AND APPARATUS”, titled “BIOMETRIC AUTHENTICATION SYSTEM”, titled “PAYMENT INITIATION AND ACCEPTANCE SYSTEM”, and titled “SYSTEMS, METHODS AND COMPUTER PROGRAM PRODUCTS FOR THE RECEIPT OF TRANSACTION OFFERS”, which are assigned to the assignee of this application.

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

The transaction apparatus as described herein may be, in some embodiments, associated with a mobile device, such as being a case or attachment for a mobile device. In other embodiments, the transaction apparatus may be a standalone device. The transaction apparatus typically includes a processor and memory device. The transaction apparatus may be configured, in various embodiments, for receiving, storing, encrypting, decrypting, encoding, decoding, accessing, transferring, writing and/or presenting data including, but not limited to, financial data, authentication data, identification data, personal data, and/or other data associated with a user. The financial data may be or include data such as credit and/or debit card data captured or input from a credit and/or debit card, account data such as demand deposit account (DDA) data such as checking account data, savings account data or data related to other types of accounts owned and/or associated with a user.

In some embodiments, the transaction apparatus may receive data by communication with a mobile device, by communication with a detachable magnetic strip reader (used to read, for example, a credit/debit card having a magnetic strip), by still photography or video capture (such as by image capture and decoding of a 2D or 3D barcode or by image capture and decoding, if necessary, of a check or other financial document), by accessing the

Internet via a network, by communication with a biometric reader, by receiving manual input by a user, and/or the like. Communication with the mobile device may be through a direct hardwire connection or network connection such as a connection through a wireless network such as a cellular phone provider wireless data network or a WiFi intranet or extranet and/or the Internet, a Near Field Communication (NFC) connection, a Bluetooth® connection, a Bluetooth® Lite connection and/or the like. The detachable magnetic strip reader may attach to the transaction apparatus, the mobile device, or another device in communication with the transaction apparatus or mobile device. The attachment may, in some embodiments be though a hardwire connection such as through a USB port, micro-USB port, microphone port, other type of connector or the like, or through a wireless or hardline network connection.

In some embodiments, the data received may then be stored within the transaction apparatus. In some embodiments, the data may be stored in the transaction apparatus such that a mobile device or other device associated with the transaction apparatus may not have access to the data stored within the transaction apparatus. In some embodiments, the data may be stored in the transaction apparatus such that a mobile device or other device associated with the transaction apparatus may have limited access to the data stored within the transaction apparatus. The data stored within the transaction apparatus may be encrypted such that unwanted attempts to access the data may be denied. Furthermore, the data stored within the transaction apparatus may be protected because the connector(s) of the transaction apparatus are utilized by the processor such that pin assignments differ from standard pin assignments and, therefore, a peripheral attempting connection with the connector(s) of the transaction apparatus may not receive power from the expected pin, may not be able to transfer data over expected pins, and/or may be able to decode and/or decrypt data that stored and/or accessed from the transaction apparatus.

In some embodiments, a user of the transaction apparatus may access the data stored within the transaction apparatus. Prior to allowing access to all of the financial, identification, personal, and/or other data that is stored within the transaction apparatus, the user may be required to present authorization data to the transaction apparatus to ensure the user is authorized to access the data. The authorization data may be presented by the user to the mobile device, the transaction apparatus or a peripheral device, such as the magnetic strip reader or otherwise. The authorization data may include biometric data, such as fingerprint data captured by scanning a user's finger, retinal data captured by scanning a user's eye(s), etc., data corresponding to a user's personal identification number (PIN), shape or object recognition authorization, and the like. The authorization, if accepted, may allow a user to utilize the data stored within the transaction apparatus. However, in some embodiments, the data may only be utilized for specific tasks. For example, some and/or all of the data may not be communicated from transaction apparatus to the mobile device despite successful authorization of the user.

The user may access and view portions of the data via his/her mobile device display utilizing an application or other program associated with the transaction apparatus. For example, if a user provided credit card data to the transaction apparatus, such as via the magnetic strip reader, the user may now be presented with a representation of some or all the credit card data via the application. The representation may include information that would be found on a typical credit card, such as an account number, name associated with the account, type of card, etc. However, the transaction apparatus may have also stored additional data captured from the magnetic strip on the credit card. Data such as a Card Verification Value One (1) (CVV1) code may be captured to the transaction device, and the transaction device may not divulge (or may not immediately divulge) the CVV1 code to the mobile device, application and/or user. In this way, certain information may be stored within the transaction apparatus and not communicated to a mobile device or the like.

Accessing and viewing a representation of the data stored within the transaction apparatus on a display allows a user to select the financial, identification, personal and/or other data that the user may wish to use during a transaction. For example, the user may have multiple credit cards and/or debit cards that he/she may select when purchasing a product or service from a merchant. The user may select the one or more credit or debit cards that he/she may wish to use for the transaction.

Once the user selects the data from the display, the mobile device may present the selection to the transaction apparatus. The transaction apparatus will determine what data is stored in association with the user's selection and transfer that data to an output device.

In some embodiments, the transaction apparatus may present the selected data via an output device associated with the transaction apparatus. In this way, the output device may receive all data stored in the transaction apparatus associated with the selected financial account, identification, or the like. Output devices may include, but are not limited to, a writable transaction card, E-ink display, other display and/or the like. In one example, the user may select financial account data associated with a debit card. The transaction apparatus may access the stored data associated with the debit card, such as, but not limited to, the card account number, security number, name associated with the account, expiration date, any other data stored on the magnetic strip, etc. The transaction apparatus may then communicate some or all the data to the writable transaction card associated with the transaction apparatus. As such, the writable transaction card may now be utilized as the debit card by the user for payments (or for withdrawals in some embodiments) at a merchant point of sale, ATM, bank, etc. In this way, the writable transaction card associated with the transaction device may be used by the user in place of the debit card. In another example, the user may select loyalty account data associated with a merchant. The loyalty account data may have been captured from a photograph of a barcode and/or number associated with the loyalty account. The transaction apparatus may then build a graphic of the bar code and store the graphic in association with that loyalty account. Upon selection of the loyalty account data, the transaction apparatus may access the bar code information and/or graphic, merchant associated with the loyalty account, loyalty account number, etc. The transaction apparatus may then communicate some or all the data to an E-ink display or other display associated with the transaction apparatus. The user may utilize the bar code on the E-ink display in place of his/her loyalty account card.

Upon completion of a user utilizing the data for a transaction via an output device, the output device may be programmed to erase any or all data from its memory/magnetic strip/etc. and/or the transaction apparatus may time-out the output device if it is connected to the transaction apparatus. In this way, the data may be removed from the output device to prevent misuse of the data.

In summary, embodiments of the invention are directed to a data reader for reading data from a device associated with a user. In various embodiments, the data reader is or includes a magnetic strip reader, a chip card reader, a Near Field Communication device or other RFID device, an Infrared (IR) communication device or other communication device configured to read, extract or otherwise receive data or information associated with a user, such as financial data, personal data or otherwise. In some embodiments, the data reader reads financial data such as bank account data from a transaction device such as a bank card (credit and/or debit), a chip card or the like and communicates some or all the data to another device, such as a transaction apparatus 130 and/or a mobile device 150 of a user.

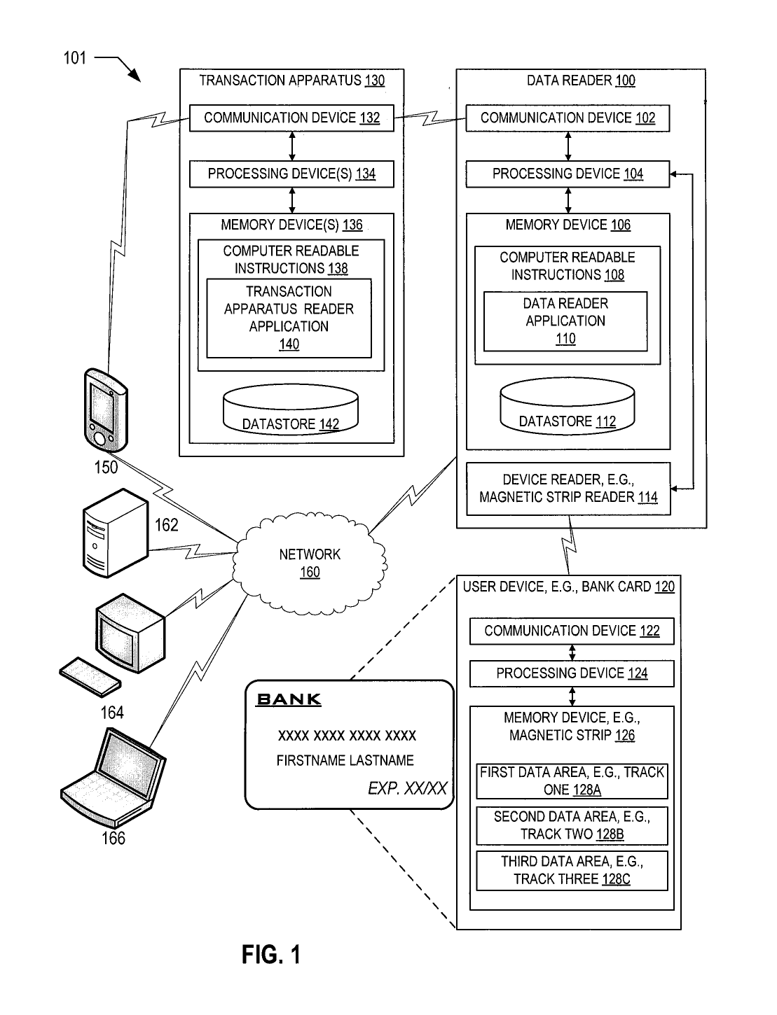

Referring now to FIG. 1, an environment 101 in which a data reader 100 operates according to embodiments of the invention is shown. In some embodiments, the data reader 100 includes a communication device 102 connected with a processing device 104. The processing device 104 may also be connected with a memory device 106, that in some embodiments, stores computer readable instructions 108 including a data reader application 110. In some embodiments, the memory device 106 also is or includes a datastore 112. The data reader 100 also includes a device reader 114 for reading a user device 120 such as a bank credit or debit card.

The communication device 102 may be or include a connector and/or port for communicating via a hardline connection with another device, such as a transaction apparatus 130. In various embodiments, the connector and/or port may be or include one of the various types of USB connector, such as a micro-USB connector, or another type of connector, such as a Firewire connector, a 30-Pin connector or the like. In various embodiments, the communication device 102 is or includes wireless communication abilities for communicating with another device, such as transaction apparatus 130. In various embodiments, the communication device 102 is configured for communicating with another device using Bluetooth®, Bluetooth® Lite, NFC, WiFi, IR or the like.

The device reader 114 reads, extracts or otherwise receives data from a user device 120 such as a bank card. The device reader may be or may be part of the communication device 102 of the data reader 100, may be a standalone, co-located device of the data reader 100, or may be a standalone, peripheral connected (hardline or wirelessly) with the data reader 100. In some embodiments, the device reader 114 is capable of reading data from multiple data areas, e.g., 128A, 128B and 128C of the user device 120.

In some embodiments, the device reader 114 is or includes a magnetic strip reader for reading a magnetic strip of a bank card, such as a credit or debit card. The magnetic strip reader may be capable of reading multiple tracks of data from the magnetic strip of the bank card. For example, the magnetic strip reader may be capable of reading Track One (1), Track Two (2) and Track Three (3) data from the magnetic strip of a typical bank card.

In various embodiments, the device reader 114 is or includes a chip card reading device, an NFC device, or another device for using Bluetooth®, Bluetooth® Lite, WiFi, IR or the like to read, extract or receive data from the user device 120.

In one example, the data reader 100 includes a magnetic strip data reader 114, and a user swipes his or her credit card. The magnetic strip data reader 114 captures data from all three tracks stored in the magnetic strip of the credit card and forwards that data to the processing device 104, if applicable, of the data reader 100.

In embodiments where the processing device 104 receives some or all the data read, extracted or received by the device reader 114, the processing device 104 may then process the data, such as by performing one or more of the steps of interpreting the type of data received, determining whether to communicate some or all the data received from the device reader 114 using the communication device 102, such as to a transaction apparatus 130, encoding some or all the data received and/or some or all the data to be communicated, encrypting some or all the data received and/or some or all the data to be communicated, outputting some or all the data to be communicated according to a non-standard communication protocol or communication hardware configuration to bolster security of the communication or the like. One of more of these steps performed by the processing device 104 and/or other steps may be caused by the processing device executing computer readable instructions and/or program code 108 stored in a memory device 106 of the data reader 100. These computer readable instructions 108 may be or include a data reader application 110, which may be firmware stored in or in close proximity with the processing device 104, such as by a manufacturing entity or may be stored in a memory external to the processing device 104. In some embodiments, the data reader also has a datastore 112 where the processing device 104 may store some or all the data read by the device reader 114.

In some embodiments, however, the data reader does not include a standalone processing device 104, but rather, the device reader 114 includes logic that may or may not include a processing device or no processing device is included in the data reader 100.

For example, the device reader 114 may capture the data from the tracks of the magnetic strip, convert the data using one or more hardware conversion techniques in order to condition the data for communication over the communication device 102 of the data reader 100 and forward the data.

The user device 120, as discussed, may be a bank card, such as a credit or debit card or may be any other type of card having information indicated thereby. Various examples of cards are chip cards, combination chip card/magnetic strip cards, NFC enabled cards, loyalty cards, cards having indicia such as 1D, 2D and/or 3D informational barcodes, one or more aliases, one or more character strings or the like. In some embodiments, the user device 120 may be or include a mobile device such as a smartphone, personal digital assistant (PDA), cellular phone, music (e.g., mp3) player, or the like. In some embodiments, the user device 120 may be or include a device that is owned, maintained, operated, held, and/or the like by a user other than the user of the data reader. In this regard, data associated with an individual other than the user of the data reader may be captured. In some embodiments, the user device 120 has a communication device 122 connected with a processing device 124. Some such devices are chip cards, mobile devices, or the like. For example, in one embodiment, the user device is a transaction apparatus similar or identical to the transaction apparatus 130 and/or a mobile device connected with a transaction apparatus similar to transaction apparatus 130. In this way, the user device 120 may be running the data reader application 110 or similar application such that the processing device 124 may cause the communication device 122 to communicate directly with the communication device 102 of the data reader 100. This communication may be performed over a hardwire connection, such as through a USB connection or may be wireless, such as over a wireless network such as by using WiFi or over the Internet using one or more wireless data connections such as cellular wireless networks, Bluetooth®, Bluetooth® Lite, IR, NFC or the like.

The transaction apparatus 130 may have a communication device 132, one or more processing devices 134, and one or more memory devices 136 configured for storing computer readable instructions 138. The computer readable instructions may include a transaction apparatus reader application 140, among others, which causes the processing device 134 to perform one or more of the steps of communicating with the data reader 100, communicating with a mobile device 150, and/or the like. The transaction apparatus 130 may include significant additional functionality as briefly discussed above, but the details of such are not discussed herein. The transaction apparatus 130 may also have a datastore 142 to, for example, store data captured by the data reader 100.

The data reader 100 may be part of the transaction apparatus 130, that is, it may an integral part of the transaction apparatus 130 and/or may be an integral part of the mobile device 150. In other embodiments, the data reader 100 may be a peripheral attachment that can be removably attached to the transaction apparatus 130, the mobile device 150 or both/either. In some embodiments, the data reader 100 is integrated into or is removably attachable to one or more other devices such as a tablet computer, a server 162, a computer 164, a laptop 166 and/or the like. In various embodiments, the data reader may be capable of communicating across a network 160, which may include one or more of a peer-to-peer connection, an intranet, an extranet, the Internet, a cellular wireless network or the like. Accordingly, in some embodiments, the data reader 100 may communicate with one or more devices such as the transaction apparatus 130, the user device 120, and/or one or more other devices.

For example, in some transactions involving the data reader 100, the data reader 100 is not physically attached to another device, but rather, communicates exclusively over the network 160. In one such transaction, the data reader may receive data from another device attempting to make a payment and/or another device attempting to present data for use in future purchase transactions. For example, a user may send data regarding a bank account to the data reader 100 for either making a payment to a device connected with the data reader 100 and/or for being stored and used in a future transaction by a device connected with the data reader 100, such as transaction apparatus 130.

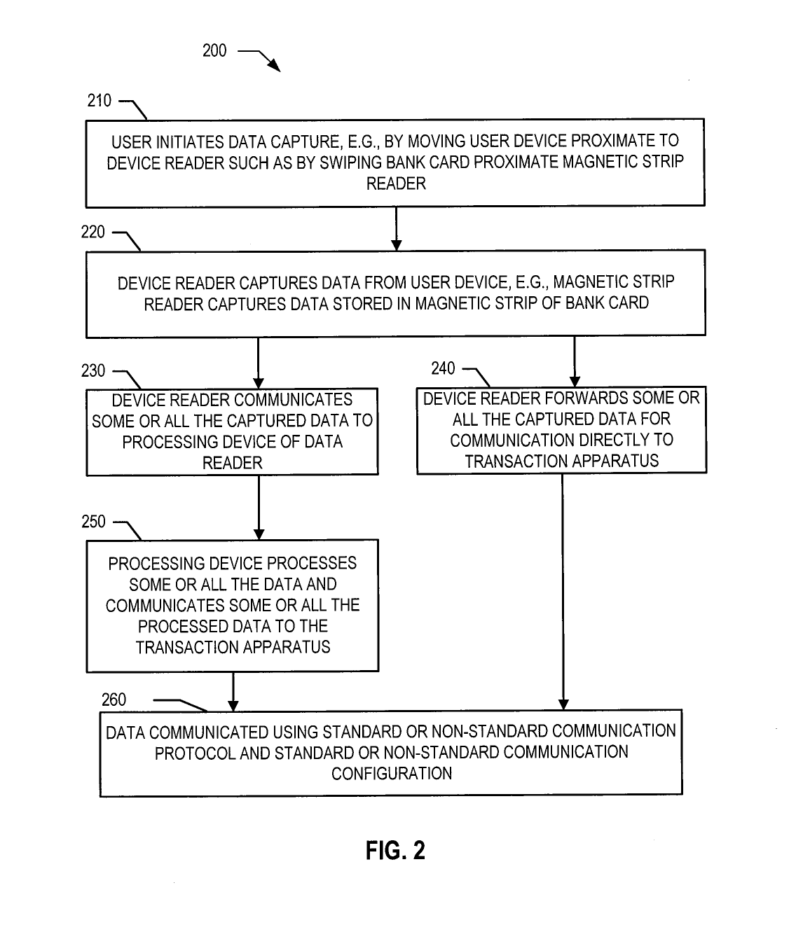

Referring now to FIG. 2, a flowchart illustrates a method 200 for capturing data using the data reader according to embodiments of the invention. The method 200 includes a user initiating the data capture, as represented by block 210. The data capture may be initiated by the user moving a user device in proximity to the device reader of the data reader. For example, the user may swipe a bank card having a magnetic strip through a magnetic strip reader of the data reader. In some embodiments, initiation of the data capture is performed remote to the data reader, such as by one or more remote devices that automatically, or in response to a user's direction, communicate with the data reader over a network or otherwise. Thus, the data capture may be initiated by the user associated with the data reader and its corresponding transaction apparatus or may be initiated by another user or another system.

The next step, as represented by block 220, is a device reader captures data from a user device. The user device, as discussed above, is a bank card and includes a magnetic strip that is read by a magnetic strip reader of the data reader. In other embodiments, the device reader captures data from one or more other devices, such as a chip card, an NFC capable device, a mobile device, or a remote device. In some embodiments, the device reader is or includes a camera or other image capture device that captures data from one or more still or motion images. For example, in one embodiment, the device reader is configured for capturing one or more images of a barcode, and in another embodiment, the device reader is configured for capturing one or more aliases, other indicia, words, or strings of characters from a card or other object, such as capturing information from a check associated with an account of a user. In other embodiments, the device reader is capable of capturing data from another device, such as another transaction apparatus, either by initiation from the other transaction apparatus or by initiation from a user of the data reader and subsequent communication and/or coupling with the other apparatus. In some embodiments, the data reader communicates with the user device in one communication protocol and/or configuration and communicates with the transaction apparatus in another, different communication protocol and/or configuration. For example, in one embodiment, the data reader communicates, using the device reader, with the user device by NFC and communicates with the transaction apparatus using Bluetooth® or Bluetooth® Lite. In another example, the device reader communicates with the user device using a hardline connection whereas the data reader communicates with the transaction device using a wireless connection or communication. In other embodiments, the reverse holds true, that is, the device reader communicates with the user device using a wireless connection or communication and the data reader communicates with the transaction apparatus using a hardline connection or is integrated within or attached to the transaction apparatus.

The next step, as represented by block 230, is the device reader communicates some or all the captured data to the processing device of the data reader. Alternatively, or in combination, the device reader forwards some or all the captured data for communication directly to the transaction device, as represented by block 240.

Steps 230 or 240 typically refer to a communication that is immediate upon the data being captured. For example, a credit card is read by the device reader and the captured data is converted to electromagnetic signals and sent to the processing device for processing. In some embodiments, the device reader forwards some or all the data to the transaction apparatus, typically through the communication device of the data reader (step 240). Sending the captured data directly, that is, without being sent to a processing device, may be advantageous if little or no conditioning, encoding, encryption or other processing is necessary before communicating to the transaction apparatus in that time and power may be conserved.

As represented by block 250, the captured data that is communicated to the processing device is processed. This processing may include one or more of encoding, encrypting, extracting desired portions of data, conditioning such as amplifying, filtering, sampling and the like. For example, the processing device may receive an unconditioned signal from the device reader that represents data read from a user device. The processing device may interpret the signal from the device reader based on known parameters corresponding to the device reader that enable the processing device to decode the signal from the device reader. In some embodiments, the device reader sends an decoded, unprocessed, “raw” signal to the processing device. In most embodiments, the processing device must interpret the received signal if determination of the data represented therein is desired, however, in various embodiments, the data need not be determined by the data reader processing device, but rather, the signal must merely be conditioned for communication based on the appropriate communication protocol and configuration.

In some embodiments, the processing device encodes the data read from the user device. In this regard, the data may be combined or multiplexed so that it can be sent over a single data line in real time or near real time. Thus, in some of these embodiments, no storage of the data read by the device reader is necessary, but rather, the data is captured, sent to the processing device, encoded (e.g., multiplexed), and output to a communication device such as a connector.

In some embodiments, data may be captured from different data areas, such as is the case with data read from a magnetic strip. This data may be contained within different tracks within the magnetic strip. The processing device may interleave the data from the multiple tracks in order to reduce is to one data bitstream for ease of subsequent communication. In some embodiments, the single data bitstream is communicated in combination with a clock signal such that a received device, such as a transaction apparatus may decode the interleaved bitstream using a predetermined algorithm stored by the transaction apparatus and the clock signal. Thus, in some embodiments, the data reader application and the transaction apparatus reader application have program code structured to work together, that is, the data reader application may encode the bitstream that is received by the transaction apparatus for decoding by the transaction apparatus reader application. In other words, the bitstream received by the transaction apparatus, in some embodiments, must be encoded in a manner recognized by the transaction apparatus reader application. If the transaction apparatus reader application (TARA) 140 does not recognize the encoding of the bitstream, then the TARA may perform one or more of the following steps: present a message to the user, send a message to the user or other entity, such as a message indicating an improper data download was attempted, and/or lock or disable the transaction apparatus for further use temporarily (until it can be unlocked by an authenticated user or otherwise), semi-permanently (until it can be unlocked by an administrative entity such as a financial institution), or permanently. In some embodiments, the bitstream will be rejected by the TARA 140, and then the transaction apparatus will remain unlocked, but will keep a running total of the number of rejected bitstreams. Once the total reaches a predetermined threshold, the TARA may lock or disable the transaction apparatus as discussed above.

In some embodiments, the encoding does not require a clock signal, but rather, relies on the power signal provided by the transaction device to the data reader in place of a specific clock signal provided by the data reader to the transaction apparatus. In this regard, fewer data lines are required for transmission of the data.

As represented by block 260, data is then communicated using standard or non-standard communication protocol and/or communication configuration. For example, in some embodiments, a communication protocol standardized based on a public standard is used to communicate data from the data reader to the transaction apparatus. In other embodiments, a non-standard communication protocol is used to communicate data from the data reader to the transaction apparatus. In such instances, the TARA 140 and the data reader application 110 must include instructions matched such that the communication from the data reader may be properly interpreted by the transaction apparatus. For example, as discussed above, the data reader may encode the data in a bitstream using a proprietary algorithm such that only a receiving device that is programmed to decode the bitstream using the proprietary algorithm will be able to decode the bitstream.

Furthermore, the TARA 140 may utilize a standard communication configuration, namely, a standard communication configuration for pin assignment of connectors, cables, and the like. For example, the TARA 140 may be configured to output one or more data bitstreams over a micro-USB connection with the transaction apparatus. Continuing with the example, the TARA 140 may instruct the processing device 104 of the data reader 100 to output an interleaved (or otherwise encoded) data bitstream representing some of all the data read from a user device using either pin two (2) or pin three (3) as the data line and the other pin, pin three (3) or pin two (2), respectively, as the clock signal. Further, in a standard communication configuration, power is provided using pin one (1), pin four (4) is unused and pin five (5) is ground. In some embodiments where a standard communication configuration is used, the standard pin assignments for the connector, cables and the like are physically connected to output pins of the processing device 104, and therefore, the processing device 104 does not necessarily need to know the communication configuration being used to output data from the data reader.

In other embodiments, a non-standard communication configuration is used. Such a configuration may involve changing the pin assignments used in communication from the data reader to the transaction apparatus. For example, in one embodiment, a micro-USB connector is used for connecting with the transaction apparatus. However, pin four (4) is used for the power pin and pin one (1) is unused. In this way, the data reader receives its power (if it is not self-powered) from the transaction apparatus over pin 4. The data lines remain pins 2 and 3. In various other embodiments, different communication configurations may also be used. In this way, the data reader may output data over non-standard pins and/or may be powered using non-standard pins, and therefore, if a user attempts to use a non-approved data reader or a non-approved transaction apparatus, then the approved device will not recognize the non-approved device, will not power the non-approved device, or will not recognize the data being sent from the non-approved device and/or the non-approved device will not be able to recognize the data it receives from an approved device.

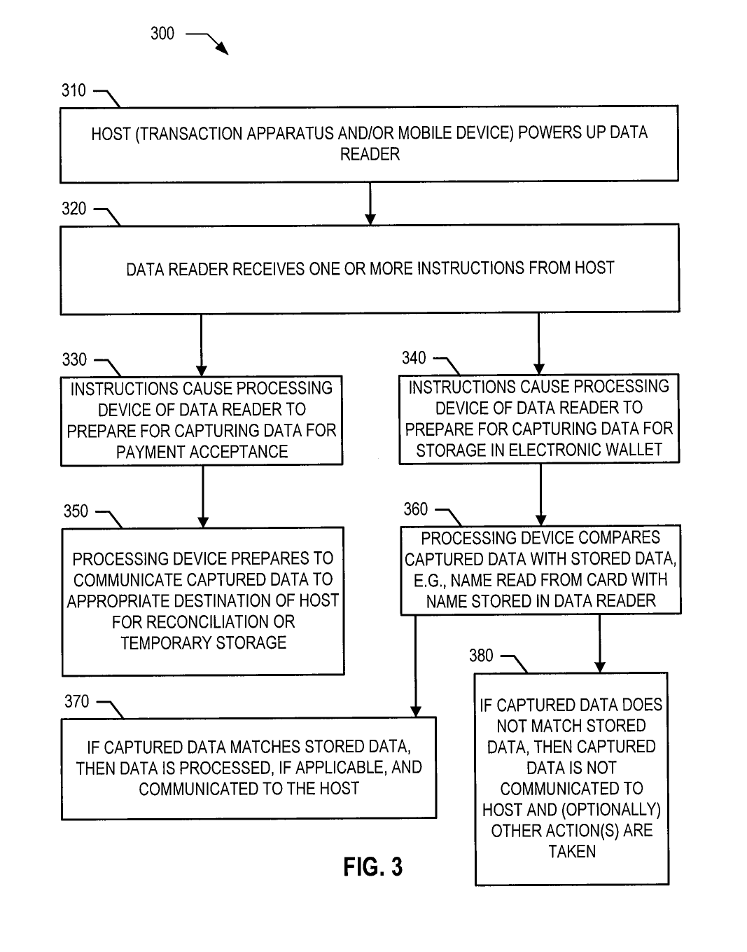

Referring to FIG. 3, a method 300 including various additional steps that may be performed during a data capture using the data reader. In some embodiments, none, on or more of the steps of method 300 may be performed in combination with one or more of the steps of method 200. The method 300 includes a host, such as a transaction apparatus and/or a mobile device) powering up the data reader, as represented by block 310. In some embodiments, the powering occurs when the data reader is attached and/or connected with the host, such as via a micro-USB connection. In other embodiments, powering of the data reader only occurs after preliminary authentication of the data reader. For example, in some embodiments, the data reader has a unique identifier stored therein, and a processing device of the transaction apparatus retrieves the unique identifier stored in the data reader to compare it to an identifier stored in the transaction apparatus. In some embodiments, the data reader and the transaction apparatus were matched during manufacture and the unique identifier was stored in both devices, in other embodiments, the data reader and the transaction apparatus were matched together during the first connection between the two devices by the user. For example, the unique identifier may have been stored by the transaction apparatus initially and downloaded to the data reader and stored there during an initial connection between the two. Thus, during any subsequent connections between the two devices, the unique identifier may be read and compared by the transaction device to ensure the data reader is authorized to communicate with the transaction apparatus.

In some embodiments, an application is running on the transaction apparatus and/or a mobile device connected with the transaction apparatus that facilitates powering up the data reader once authentication of the user's identity has been performed by the transaction apparatus and/or the mobile device. In some embodiments, the data reader includes an authentication device. In one embodiment, the data reader includes a biometric reader for authenticating the identity of the user. The data reader may authenticate the identity of the user and communicate data indicating the authentication to the transaction apparatus in some embodiments. In some embodiments, the authentication device of the data reader may authenticate the user, capture data from the user and store the data on the data reader for subsequent uploading of the data to one or more transaction apparatuses. In some such cases, the authentication indication is also uploaded so that the transaction apparatus need not perform additional user identity authentication.

The host may power up the data reader after an authenticated user has indicated to the application running on the transaction apparatus and/or the mobile device that the user desires to user the data reader to capture data, either for storage in an electronic wallet, for payment initiation and/or for payment acceptance.

The next step, as represented by block 320, is the data reader receiving one or more instructions from the host. For example, in some embodiments, the data reader may receive instructions for capturing data from a particular type of user device, such as a Bluetooth-enabled user device. In this regard, the data reader may be scanning for any Bluetooth-enabled devices for connection. In some embodiments, the instructions are initiated by a user, such as via an application interface running on the transaction apparatus and/or the mobile device, and/or automatically from the host, such as when the data reader is connected to the host (and authenticated if necessary), then the host may provide instructions that the data reader operate in a potential data capture mode indefinitely or for a predetermined period of time.

In some embodiments, the data reader includes a user interface of receiving input from a user such as one or more input keys, e.g., a keypad, for receiving simple input indicating that the data reader should enable its data capture abilities or more complex input such as alpha-numeric input, a touch screen for receiving touch input, a microphone for receiving audible instructions or the like such that the data reader may receive instructions from the user, such as instructions for enabling its data capture abilities. In some embodiments, data representing user input may be communicated to the host for additional action or consideration before the data reader takes action. For example, in some embodiments, the data reader communicates the user input to the host and waits for the host to interpret the user input and send instructions back to the data reader.

The next step is, as represented by block 330, instructions cause the processing device of the data reader to prepare for capturing data for payment acceptance or, as represented by block 340, instructions cause the processing device of the data reader to prepare for capturing data for storage in an electronic wallet of the transaction device and/or for immediate use in performing a payment transaction. If the instructions indicate that the data is being captured for payment acceptance, then the next step is the processing device prepares to communicate the captured data to the appropriate destination within or proximate to the transaction device for reconciliation or temporary storage and subsequent reconciliation of transaction information, as represented by block 350.

If the instructions indicate, on the other hand, that the data is being captured for storage in an electronic wallet or for immediate use in a payment transaction, then the next step is the processing device comparing the captured data with stored data, as represented by block 360. For example, the processing device may compare a name read from a specific data area of the user device, with a name stored in the data reader to authenticate the owner of the data reader with the owner of the user device. If the captured data matched the stored data, then the data is processed, if applicable, and communicated to the host (i.e., transaction apparatus and/or mobile device), as represented by block 370. If the captured data does not match the stored data, then the captured data is not communicated to the host, as represented by block 380, and other actions may also be taken. For example, the data reader may be locked or disabled temporarily, semi-permanently or permanently. Such a lock may be removed, in some embodiments, by the user unlocking the data reader by inputting an unlock code or otherwise indicating a user's desire to unlock the data reader. In cases where the data reader is locked, it may not read data at all or it may continue to capture data of user devices but may not be allowed to communicate that data until unlocked. In some embodiments, in order to unlock the data reader, a user must authenticate using the connected host device and/or must authenticate using an authentication device of the data reader.

In various embodiments, prior to outputting data from the data reader, some or all the data is encrypted such that the data is only accessible using the corresponding keys/decryption techniques. In this way, the encrypted data may be cordoned off from certain hardware/software or otherwise. For example, in one embodiment, some or all the data communicated from the data reader to a transaction device is encrypted using public key encryption techniques. This data is destined for the memory of the transaction device. However, the transaction device may also be connected to a mobile device that is running an application having a user interface and that is connected to a cellular wireless network. Hence, the application may have additional security risks associated therewith, such as being vulnerable to virus, hacking, etc. The encrypted data may pass through the mobile device and may be “seen” by the application, but neither the mobile device (and any other application running thereon) nor the application may decrypt the data to determine its contents. In this regard, the encrypted data may be forwarded to the transaction device memory without additional security risk. In some embodiments, the encrypted data is forwarded directly to the memory of the transaction apparatus and is stored as encrypted data. Thus, if the mobile device and/or the application running on the mobile device accessed the memory of the transaction apparatus it may not be able to retrieve and decrypt the data to discern its contents. In some such embodiments, when the processing device of the transaction apparatus retrieves the encrypted data for use during a transaction, the processing device decrypts the data using a key stored proximate the processing device, such as in a memory internal to the processing device or otherwise. Thus, the data may be decrypted solely for its intended purpose.

In various embodiments, the data reader has more than one device reader. For example, in one embodiment, the data reader has a magnetic strip reader and an NFC device for reading multiple data areas using different reading technologies. In this regard, the data reader may be used for a versatile array of applications and/or may be used to read complex user devices. For example, the data reader may be capable of communicating with a mobile device using more than one protocol. The data reader may communicate with a mobile device via Bluetooth connection as well as via a WiFi network. In such a scenario certain data may be communicated using one protocol and other data may be communicated using another protocol. In some instances or for limited periods of data transmission or otherwise, the data being communicated may be identical, and thereby, provide a check on data accuracy. In some instances, one protocol may communicate encrypted data and another protocol may communicate some type of key for decrypting. In some embodiments, multiple instances of a similar communication protocol are enabled. For example, in one embodiment, the data reader is capable of simultaneous communication with multiple wireless networks. The data reader may be connected to multiple WiFi hotspots or connection nodes such that it is communicating with multiple, distinct local area networks and can communicate different data using the different connections. In another embodiments, the processing device connects using multiple network or multiple communication protocols in order to improve speed of communication by sending some of the data via a first communication channel and other data over a second communication channel and so forth such that the data bandwidth of multiple networks may be utilized.

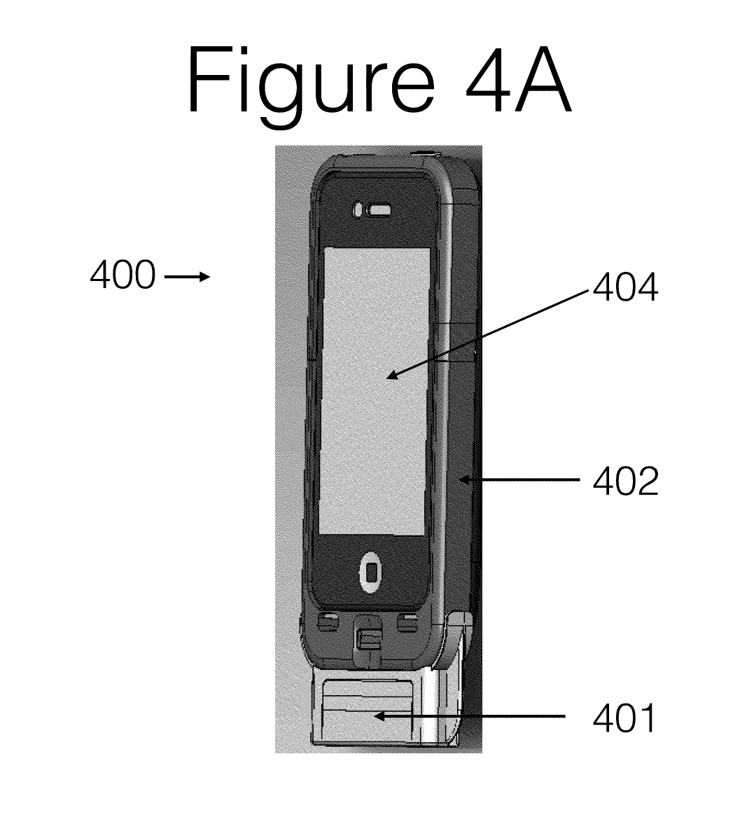

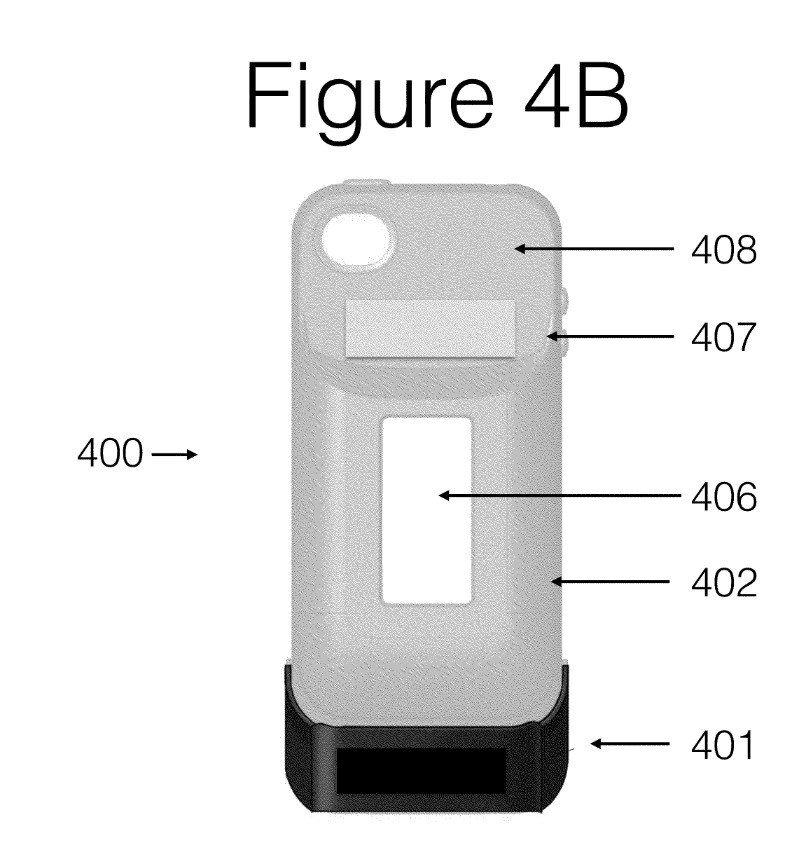

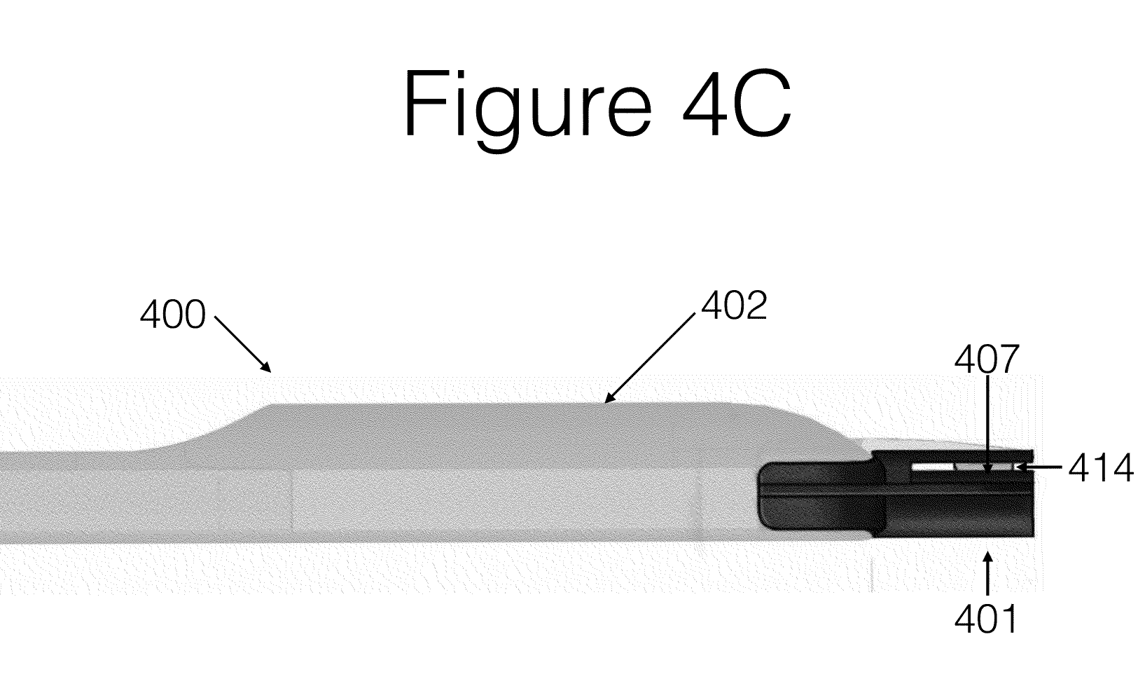

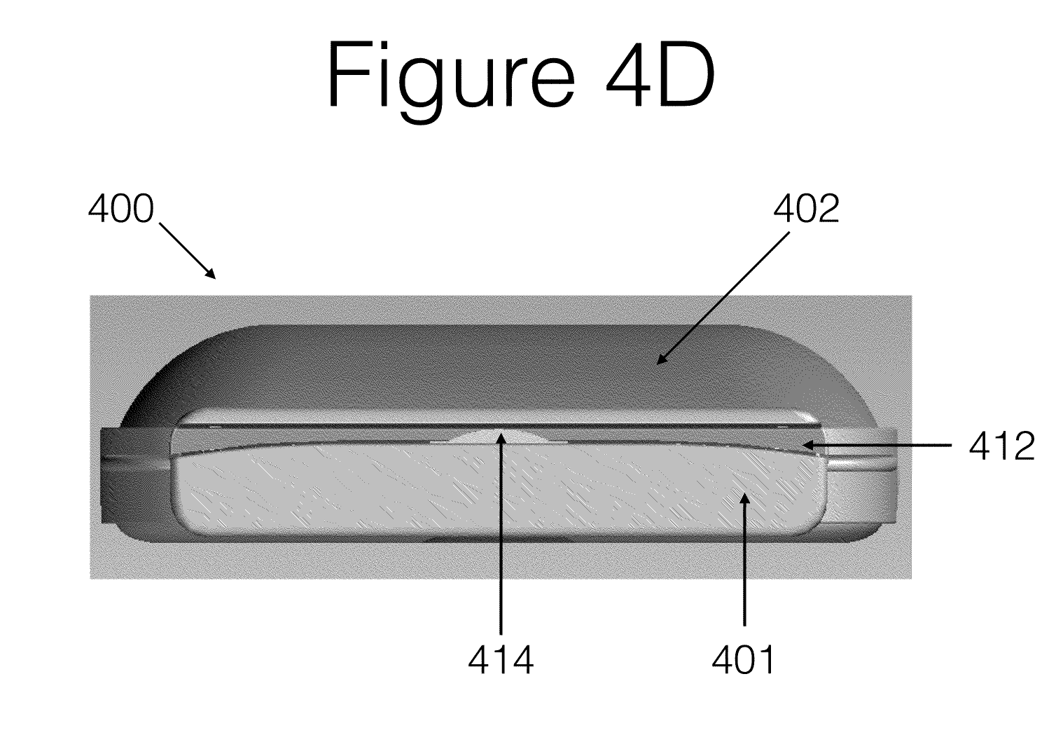

Referring now to FIGS. 4A, 4B, 4C and 4D, a representation of a system 400 including a data reader 401 according to embodiments of the invention is shown. The system 400 includes a transaction apparatus 402, which in the embodiment shown is a case for attaching to a mobile device 404. The data reader 401 is a peripheral device that may be attached and detached from the transaction apparatus 402. The data reader 401 may include a communication device including a physical connector for coupling with a physical connector of the transaction device 402 or may communicate wireless with the transaction device 402 and/or the mobile device 404. Referring to FIG. 4B, a perspective view of the system 400 is shown.

The data reader 401 includes a magnetic strip reader in the embodiments shown. The transaction apparatus 402 includes a secondary display 406, such as an e-ink display and an output device portal 407 for receiving an output device 408. In the embodiments shown, the output device is a programmable card and the output device portal 407 is configured for writing data to the programmable card. Referring to FIGS. 4C and 4D, a side view of the system 400 is shown. The data reader 401 includes a slot 412 for receiving a bank card so that the magnetic strip reader 414 may read the magnetic strip of the bank card.

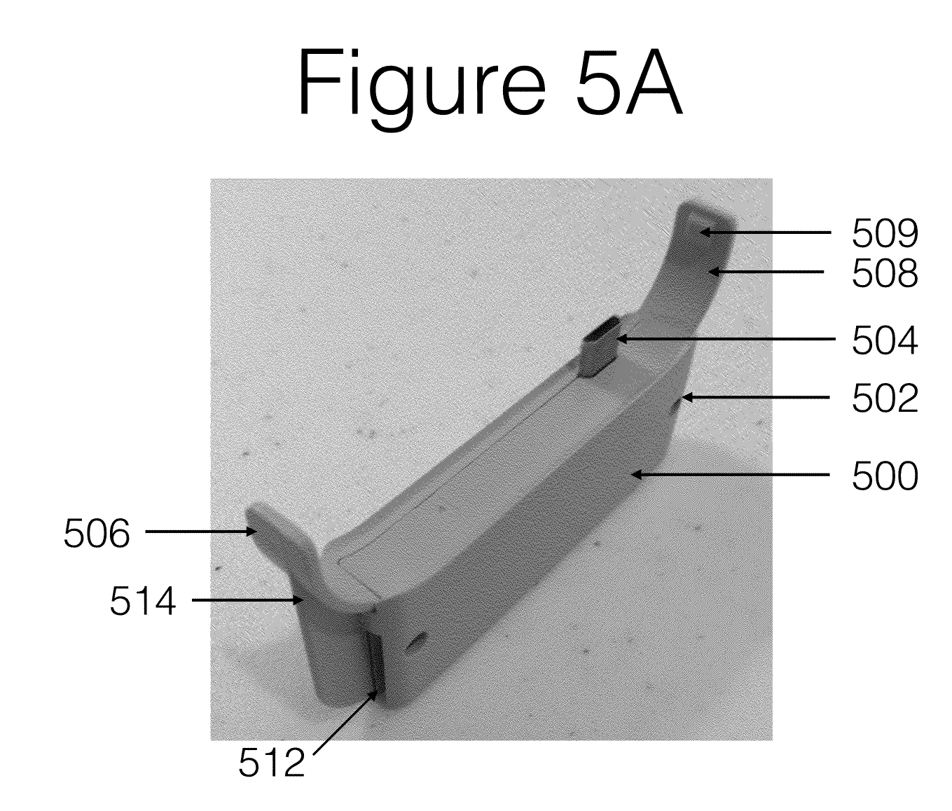

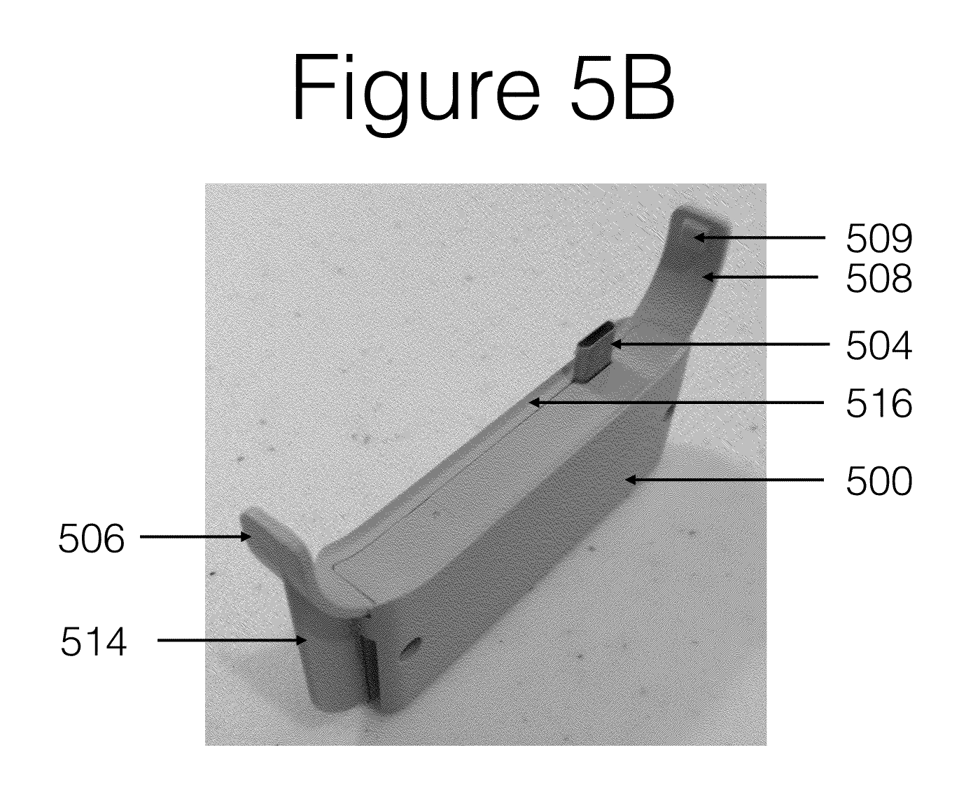

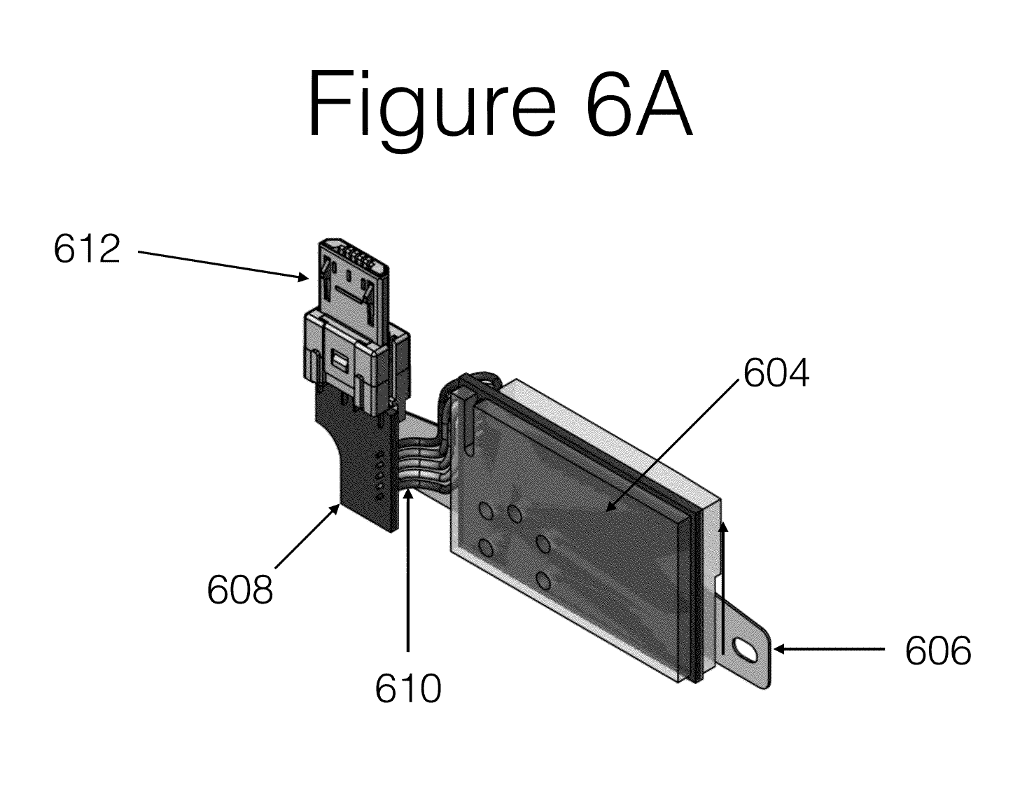

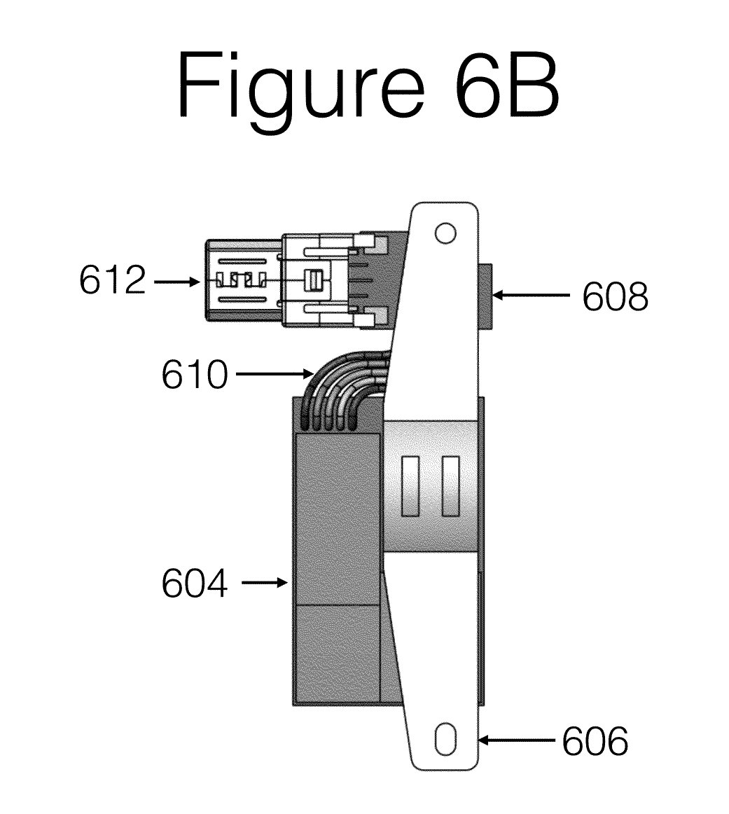

Referring now to FIGS. 5A and 5B, perspective views of a data reader 500 according to embodiments of the invention are shown. The data reader 500 has a housing 502 that is formed to accommodate a transaction apparatus, such as transaction apparatus 402 and/or mobile device 404 of FIG. 4A. A connector 504 such as a micro-USB connector as shown in FIG. 5A is connected with a processing device (see FIGS. 6A and 6B) and is capable of connecting with a female micro-USB port, such as a port on the transaction apparatus. As shown, these embodiments of the data reader 500 include attachment mechanisms 506 and 508 for attaching the data reader to the transaction apparatus. Both of the attachment mechanisms 506 and 508 have an attachment protrusion (not shown and 509) for coupling with corresponding attachment depressions (not shown) of the transaction apparatus. Both attachment mechanisms 506 and 508 are supported by support arms 514 (and not shown). The support arms support the attachment mechanisms and bias the attachment mechanisms such that the attachment protrusions are pushed inward toward the attachment depressions of the transaction apparatus when the transaction apparatus and the data reader are coupled. Referring to FIG. 5B, a rim 516 for resting against the transaction apparatus and/or the mobile device is disposed along the edge of the data reader for seating the data reader snugly against the transaction apparatus and/or mobile device when they are coupled.

Referring now to FIGS. 6A and 6B, the data reader 500 (FIG. 5A) is shown with the housing 502 removed. The magnetic strip reader 604 is attached to a mounting plate 606 for mounting the magnetic strip reader 604 to the housing of the data reader. The magnetic strip reader 604 is connected to the processing device 608 via connections 610. The connections 610 connect the processing device 608 with connector 612, which is for connecting with the transaction apparatus and/or mobile device. As shown, three connections 610 may provide data captured from the three (3) tracks of data contained within a magnetic strip of a bank card. In other embodiments, more or fewer connections are provided, and/or the three connections do not correspond with the three tracks of data contained within a magnetic strip of a bank card.

In summary, embodiments of the invention are directed to a data reader for reading data from a device associated with a user. In various embodiments, the data reader is or includes a magnetic strip reader, a chip card reader, a Near Field Communication device or other RFID device, an Infrared (IR) communication device or other communication device configured to read, extract or otherwise receive data or information associated with a user, such as financial data, personal data or otherwise. In some embodiments, the data reader reads financial data such as bank account data from a transaction device such as a bank card (credit and/or debit), a chip card or the like and communicates some or all the data to another device, such as a transaction apparatus 130 and/or a mobile device 150 of a user.

As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities.

As used herein, a “communication device” generally includes a modem, server, transceiver, and/or other device for communicating with other devices directly or via a network, and/or a user interface for communicating with one or more users. As used herein, a “user interface” generally includes a display, mouse, keyboard, button, touchpad, touch screen, microphone, speaker, LED, light, joystick, switch, buzzer, bell, and/or other user input/output device for communicating with one or more users.

As used herein, a “memory device” or “memory” generally refers to a device or combination of devices including one or more forms of non-transitory computer-readable media for storing instructions, computer-executable code, and/or data thereon. Computer-readable media is defined in greater detail herein below. It will be appreciated that, as with the processing device, each communication interface and memory device may be made up of a single device or many separate devices that conceptually may be thought of as a single device.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor/processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. A data reader for capturing data from a user device, the data reader comprising:
a device reader for reading data from the user device; and
a connector in electrical communication with the device reader, the connector configured for communicating some or all the data read from the user device.

2. The data reader of claim 1, wherein the device reader comprises a magnetic strip reader for reading data from a magnetic strip of a card.

3. The data reader of claim 1, wherein the connector comprises a micro-USB connector.

4. The data reader of claim 3, wherein the micro-USB connector comprises a non-standard connection configuration, the connector comprising:
a first pin having a standard assignment of power is not assigned power.

5. The data reader of claim 4, wherein the micro-USB connector comprises:
a fourth pin having a standard assignment of unused is assigned power.

6. The data reader of claim 1, further comprising:
a memory device; and
a processing device configured to access computer readable program code stored in the memory device, the computer readable program code structured to cause the processing device to perform the steps of:
encoding some or all the data read from the device reader; and
initiating communication of the encoded data to a transaction device or a mobile device.

7. The data reader of claim 6, wherein the encoding comprises interleaving data read from multiple data areas.

8. The data reader of claim 7, wherein the multiple data areas are three tracks of a magnetic strip of a card.

9. The data reader of claim 6, wherein initiating communication comprises initiating communication of the encoded data as a data bitstream.

10. The data reader of claim 9, wherein initiating communication comprises initiating communication of a clock signal for use in decoding the encoded data bitstream.

11. The data reader of claim 1, further comprising:
a memory device; and
a processing device configured to access computer readable program code stored in the memory device, the computer readable program code structured to cause the processing device to perform the steps of:
determining identifying information from the read data;
retrieving stored identification information;
comparing the determined identifying information with the retrieved identification information;
if the determined identifying information matches the retrieved identification information, initiating communication of some or all the read data to a transaction device or a mobile device.

12. The data reader of claim 1, further comprising:
a memory device; and
a processing device configured to access computer readable program code stored in the memory device, the computer readable program code structured to cause the processing device to perform the steps of:
encrypting some or all the data read from the device reader; and
initiating communication of the encrypted data to a transaction device or a mobile device.

13. A computer program product comprising a non-transitory computer readable medium having computer executable instructions stored therein, the computer executable instructions configured to cause a processing device of a data reader to perform the steps of:
reading data from the user device; and
initiating communicating some or all the data read from the user device.

14. The computer program product of claim 13, wherein the computer executable instructions are configured to cause the processing device of the data reader to perform the steps of:
initiating reading data from a magnetic strip of a card.

15. The computer program product of claim 13, wherein the computer executable instructions are configured to cause the processing device of the data reader to perform the steps of:
encoding some or all the data read from the device reader; and
initiating communication of the encoded data to a transaction device or a mobile device.

16. The computer program product of claim 15, wherein the encoding comprises interleaving data read from multiple data areas.

17. The computer program product of claim 13, wherein the computer executable instructions are configured to cause the processing device of the data reader to perform the steps of:
initiating communication of the encoded data as a data bitstream.

18. The computer program product of claim 13, wherein the computer executable instructions are configured to cause the processing device of the data reader to perform the steps of:
initiating communication of a clock signal for use in decoding the encoded data bitstream.

19. The computer program product of claim 13, wherein the computer executable instructions are configured to cause the processing device of the data reader to perform the steps of:
determining identifying information from the read data;
retrieving stored identification information;
comparing the determined identifying information with the retrieved identification information;
if the determined identifying information matches the retrieved identification information, initiating communication of some or all the read data to a transaction device or a mobile device.

20. The computer program product of claim 13, wherein the computer executable instructions are configured to cause the processing device of the data reader to perform the steps of:
encrypting some or all the data read from the device reader; and
initiating communication of the encrypted data to a transaction device or a mobile device.
